(19) United States
(12) Patent Application Publication
(10) Pub. No.: US 2026/0181243 A1
(43) Pub. Date: Jun. 25, 2026

(54) MEDICAL IMAGING SYSTEMS AND METHODS FOR SEGMENTATION-BASED AUTOMATIC BRIGHTNESS CONTROL

(71) Applicant: Boston Scientific Scimed, Inc., Maple Grove, MN (US)

(72) Inventor: Kirsten VIERING, Newton, MA (US)

(73) Assignee: Boston Scientific Scimed, Inc., Maple Grove, MN (US)

(21) Appl. No.: 19/419,264

(22) Filed: Dec. 15, 2025

Related U.S. Application Data
(60) Provisional application No. 63/735,982, filed on Dec. 19, 2024.

(51) Int. Cl. H04N 23/63; G06T 7/11; H04N 23/82

(52) U.S. Cl. CPC H04N 23/631; G06T 7/11; H04N 23/82

(57) ABSTRACT

An image of a target area captured by a medical device imaging system is received. The first image is captured as a portion of an accessory device component coupled to and distally extending from the medical device is partially obstructing the imaging system's field of view, causing the image to include the portion of the accessory device component. The image is segmented into a plurality of segments, including a first segment corresponding to the target area and a second segment corresponding to the portion of the accessory device component. A current image brightness value is determined for the first segment, and operating parameter(s) of the imaging system are caused to be adjusted based on the current image brightness value and a target image brightness value for the first segment. Subsequent to the adjustment, a brightness optimized image for the first segment captured by the imaging system is received.

### CROSS-REFERENCE TO RELATED APPLICATIONS

This application claims the benefit of priority from U.S. Provisional Application No. 63/735,982, filed on Dec. 19, 2024, which is incorporated by reference herein in its entirety.

### TECHNICAL FIELD

The disclosure relates generally to medical imaging systems and methods for automatic brightness control. More specifically, aspects of the disclosure pertain to segmentation-based automatic brightness control applied when accessory device component(s) partially obstruct a field of view and/or affect lighting behavior of the imaging systems.

### BACKGROUND

A medical imaging system may include an imaging device and a lighting device integrated with a medical device, such as an endoscope. The endoscope may be inserted into and navigated through a body lumen of a patient to a target area during a medical procedure. The light source may be configured to emit light onto the target area to illuminate objects and/or features within the target area to facilitate a visualization thereof in images captured by the imaging device.

Several types of endoscopic procedures may be performed using accessory devices that include “over the scope” caps or other similar structures mounted onto or coupled to a distal end of an endoscope. Examples of such procedures may include Endoscopic Mucosal Resection (EMR), Endoscopic Submucosal Dissection (ESD), and endoscopic suturing. When utilized, these caps may partially block a field of view of the endoscope's imaging device and/or alter the lighting behavior of the endoscope. For example, common effects may include a bright spot on the cap, as well as a relatively dark “tunnel” behind the cap corresponding to the target area within the images captured by the imaging device. Such effects may impact image quality and visibility during the procedures.

### SUMMARY

Aspects of techniques described herein relate to computing device-implemented methods for performing automatic brightness control. An example method includes: receiving a first image of a target area captured by an imaging system of a medical device, where the first image is captured as a portion of an accessory device component coupled to and distally extending from the medical device is partially obstructing a field of view of the imaging system, causing the first image to include the portion of the accessory device component; segmenting the first image into a first plurality of segments, including a first segment corresponding to the target area and a second segment corresponding to the portion of the accessory device component; determining a current image brightness value for the first segment; causing an adjustment to one or more operating parameters of the imaging system based on the current image brightness value and a target image brightness value for the first segment; and receiving, as a second image of the target area captured by the imaging system subsequent to the adjustment, a brightness optimized image for the first segment.

In any of the example methods disclosed herein, segmenting the first image into the first plurality of segments includes identifying a boundary between the portion of the accessory device component and the target area within the first image, and identifying the first plurality of segments based on the boundary. In some examples, identifying the boundary includes detecting one or more objects within the first image, the one or more objects including one or more of the portion of the accessory device component or one or more objects associated with the target area, and identifying the boundary based on the one or more objects detected. Additionally or alternatively, identifying the boundary includes: generating and causing display of a boundary indicator at a first location on the first image as the first image is displayed to an operator via a graphical user interface displayed on a display device, and receiving an input from an operator via the graphical user interface, the input including one or more of a resizing of the boundary indicator or a movement of the boundary indicator to a second location to indicate the boundary.

In other example aspects, determining the current image brightness value for the first segment includes determining an average pixel intensity value for a first subset of pixels of the first image including the first segment, where the average pixel intensity value is the current image brightness value.

In further example aspects, the imaging system includes a lighting device configured to illuminate the target area, and causing the adjustment of the one or more operating parameters of the imaging system includes causing an adjustment of an intensity of light emitted by the lighting device to illuminate the target area, where the intensity of light is adjusted by controlling an amount of current supplied to the lighting device. Additionally or alternatively, the imaging system includes an imaging device configured to capture the first image, and causing the adjustment of the one or more operating parameters of the imaging system includes causing an adjustment of one or more of a gain or an exposure time of the imaging device.

In some aspects, the brightness optimized image also includes the portion of the accessory device component, and the method further includes segmenting the brightness optimized image into a second plurality of segments, including a third segment corresponding to the target area and a fourth segment corresponding to the portion of the accessory device component, to generate a segmented, brightness optimized image. In such aspects, the method may further include determining a modification for the fourth segment to adjust an image brightness of the fourth segment, and generating a modified image based on the segmented, brightness optimized image and the modification. In some examples, the modification is an overlay, and generating the modified image includes applying the overlay to the fourth segment of the segmented, brightness optimized image to generate an overlay image, and combining the overlay image with the segmented, brightness optimized image to generate the modified image. In other examples, the modification is a digital gain application, and generating the modified image includes applying a digital gain factor to pixel values of the fourth segment of the segmented, brightness optimized image to generate the modified image.

In other aspects, the brightness optimized image for the first segment is a first brightness optimized image, and the method further includes obtaining a second brightness optimized image for the second segment, and generating a combined image based on the first brightness optimized image and the second brightness optimized image. Obtaining the second brightness optimized image for the second segment may include: determining a current image brightness value for the second segment; after the second image of the target area is captured by the imaging system, causing another adjustment of the one or more operating parameters of the imaging system based on the current image brightness value for the second segment and a target image brightness value for the second segment; and receiving, as a third image of the target area captured by the imaging system, the second brightness optimized image for the second segment. Causing the other adjustment of the one or more operating parameters of the imaging system based on the current image brightness value for the second segment may include controlling the imaging system to switch from operating in accordance with a first set of operating parameters to a second set of operating parameters.

In further aspects, the method may include detecting the portion of the accessory device component in the first image, and performing the automatic brightness control based on the detection.

Additionally, the techniques described herein relate to computing devices communicatively coupled to a medical device for performing automatic brightness control. An example computing device includes at least one memory storing instructions, and at least one processor coupled to the at least one memory and configured to execute the instructions to perform operations. Example operations include: receiving, from an imaging system of the medical device, an image of a target area captured by an imaging device of the imaging system as the target area is illuminated by a lighting device of the imaging system, where the image includes a portion of an accessory device component that is coupled to and distally extends from the medical device; identifying a boundary between the portion of the accessory device component and the target area in the image; generating a segmented image based on the image and the boundary, the segmented image including a first segment corresponding to the target area and a second segment corresponding to the portion of the accessory device component; determining a current image brightness value for the first segment; causing an adjustment of one or more operating parameters of one or more of the lighting device or the imaging device based on the current image brightness value and a target image brightness value for the first segment; and receiving, as a subsequent image of the target area from the imaging system, a brightness optimized image for the first segment based on the adjustment.

In some aspects, the brightness optimized image also includes the portion of the accessory device component, and the operations further include: identifying a second boundary between the portion of the accessory device component and the target area in the brightness optimized image; generating a segmented, brightness optimized image based on the boundary and the brightness optimized image, the segmented, brightness optimized image including a third segment corresponding to the target area and a fourth segment corresponding to the portion of the accessory device component; determining a modification for the fourth segment to adjust an image brightness of the fourth segment; and generating a modified image based on the segmented, brightness optimized image and the modification.

In other aspects, the brightness optimized image for the first segment is a first brightness optimized image, and the operations further include: obtaining a second brightness optimized image for the second segment; and generating a combined image based on the first brightness optimized image and the second brightness optimized image.

Further aspects of techniques described herein relate to medical systems. An example medical system includes: a medical device; an imaging system located at a distal tip of the medical device; an accessory device including an accessory device component, where a portion of the accessory device component is positioned distal of the distal tip; and a computing device communicatively coupled to at least the medical device, the computing device including: at least one memory storing instructions; and at least one processor coupled to the at least one memory and configured to execute the instructions to perform operations. Example operations include: receiving an image of a target area captured by the imaging system, the image including the portion of the accessory device component based on the positioning of the portion of the accessory device component relative to the imaging system; segmenting the image into a first segment corresponding to the target area and a second segment corresponding to the portion of the accessory device component; determining a current image brightness value for the first segment; causing an adjustment of one or more operating parameters of the imaging system based on the current image brightness value and a target image brightness value; and receiving a brightness optimized image of the target area captured by the imaging system based on the adjustment.

In any of the exemplary medical systems disclosed herein, the medical device may be an endoscope and the accessory device component may be a cap.

It may be understood that both the foregoing general description and the following detailed description are exemplary and explanatory only and are not restrictive of the invention, as claimed. As used herein, the terms “comprises,” “comprising,” “including,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. The term “exemplary” is used in the sense of “example,” rather than “ideal.” The term “distal” refers to a direction away from an operator/toward a treatment site, and the term “proximal” refers to a direction toward an operator. The term “approximately,” or like terms (e.g., “substantially”), includes values +/−10% of a stated value.

### BRIEF DESCRIPTION OF FIGURES

The accompanying drawings, which are incorporated in and constitute a part of this specification, illustrate examples of this disclosure and, together with the description, serve to explain the principles of the disclosure.

FIG. 1 depicts an example medical system.

FIG. 2A depicts an example image segmentation method.

FIG. 2B depicts an example segmented image.

FIG. 3A depicts an example method for automatic brightness control.

FIG. 3B depicts an example comparison of an image and a brightness optimized image.

FIG. 4A depicts an example image modification method.

FIG. 4B depicts an example comparison of the brightness optimized image and a modified image.

FIG. 5 depicts an example method for interleaved automatic brightness control.

FIG. 6 depicts a block diagram of a computer.

### DETAILED DESCRIPTION

As briefly mentioned above, several medical procedures may utilize accessory devices with components, such as an “over the scope” cap or other similar structures, that may be mounted on or coupled to a medical device in a manner that partially obstructs a field of view of and/or alters the lighting behavior of an imaging system of the medical device. For example, when a cap is mounted to a distal end (e.g., a distal tip) of the medical device, common effects appearing within an image of a target area captured by the imaging system may include a bright spot on the cap resulting from emitted light reflecting off of the cap, as well as a relatively dark “tunnel” behind the cap corresponding to the target area. Such effects may impact image quality, and image quality of the target area may be critical for operator visibility during the medical procedure. One example technique for improving image quality may include automatic brightness control.

Some conventional systems and methods for performing automatic brightness control may evaluate brightness across an entirety of the image, and, based on the evaluation, adjust one or more operating parameters of the imaging system to optimize a brightness or illumination of the image as a whole. For example, the image may include a plurality of pixels. As part of the evaluation, a plurality of pixel intensity values for the plurality of pixels may be averaged to determine a target image brightness value for use in the adjustment. However, given the effects of the accessory device component causing certain portions of the image to be significantly brighter (e.g., bright spot on the cap) and other portions to be significantly darker (e.g., tunnel behind the cap corresponding to the target area), the average-based adjustments made to optimize a brightness or illumination of the image as a whole may not necessarily result in an optimal brightness or illumination of the target area. Specifically, the area corresponding to the target area may still remain darker than is optimal or desirable.

Other conventional systems and methods for performing automatic brightness control may evaluate brightness in a center region of the image, and based on the evaluation, adjust the one or more operating parameters of the imaging system to optimize a brightness or illumination of the center region of the image. For example, as part of the evaluation, pixel intensity values for a subset of the pixels forming the center region of the image may be averaged, and the adjustment may be based on the average pixel intensity value for the center region. The center region may be evaluated based on an assumption that the center region is most likely to include objects and/or features of interest for visualization. However, oftentimes objects and/or features of interest may not be located at or may extend beyond a center region of the image. For example, the cap may be offset from a center of the image causing the target area to be offset from the center of the image. Additionally, based on anatomical configurations, an operator of the endoscope may be unable to navigate the medical device in a manner that would enable the objects and/or features of interest to be positioned in the center region. As another example, even if the cap is not offset, depending on a size of the center region used for the evaluation, a portion of the cap may be included along with the target area within the center region of the image, affecting the evaluation similar to the above-described brightness evaluation when performed across an entirety of the image.

Further conventional systems and methods for performing automatic brightness control may adjust the one or more operating parameters of the imaging system to reduce or eliminate hot spots, such as the bright spot on the cap. Hot spots may be comprised of saturated or near-saturated pixels (e.g., white pixels) that cause details of any objects and/or features at the locations of the saturated or near-saturated pixels to become washed out or unable to be visualized. To reduce or eliminate the hot spots, an exemplary automatic brightness control process may determine a percentage or ratio of saturated pixels, and adjust the one or more operating parameters of the imaging system until the percentage or ratio of saturated or near-saturated pixels falls below a threshold. Although such adjustment may reduce or eliminate hotspots, the adjustment may also cause remaining portions of the image (e.g., including the target area which is already dark as a result of the tunnel effect created by the cap) to become darker, which may ultimately impact the operator's ability to visualize objects and/or features of interest when they are located in the now darker portions of the image.

Therefore, aspects of this disclosure are directed to medical imaging systems and methods for segmentation-based automatic brightness control to mitigate effects resulting from an accessory device component obstructing the field of view and/or altering lighting behavior in order to help improve image quality of for the operator during the medical procedure. For example, an image of a target area including a portion of the accessory device component may be segmented to identify, among a plurality of segments, a segment corresponding to the target area, and automatic brightness control may be performed based on feedback from the segment to optimize brightness specifically for the target area.

In some examples, segmentation-based image modification may be performed in conjunction with the automatic brightness control. For example, an optimized (or otherwise improved) brightness image captured subsequent to the performance of the automatic brightness control may be segmented and modified to digitally adjust a brightness of a segment corresponding to the portion of the accessory device component. A brightness of the resulting modified image is therefore optimized or otherwise improved across both the segment corresponding to the target area and the segment corresponding to the portion of the accessory device component. In other examples, segmentation-based image modification may be performed independently of the automatic brightness control.

In further examples, the segmentation-based automatic brightness control may be performed in an interleaving manner to continuously optimize brightness for both the segment corresponding to the target area and the segment corresponding to the portion of the accessory device component. For example, optimized brightness images captured subsequent to the performance of the automatic brightness control for each of the segments may be combined to generate a holistic optimized brightness image.

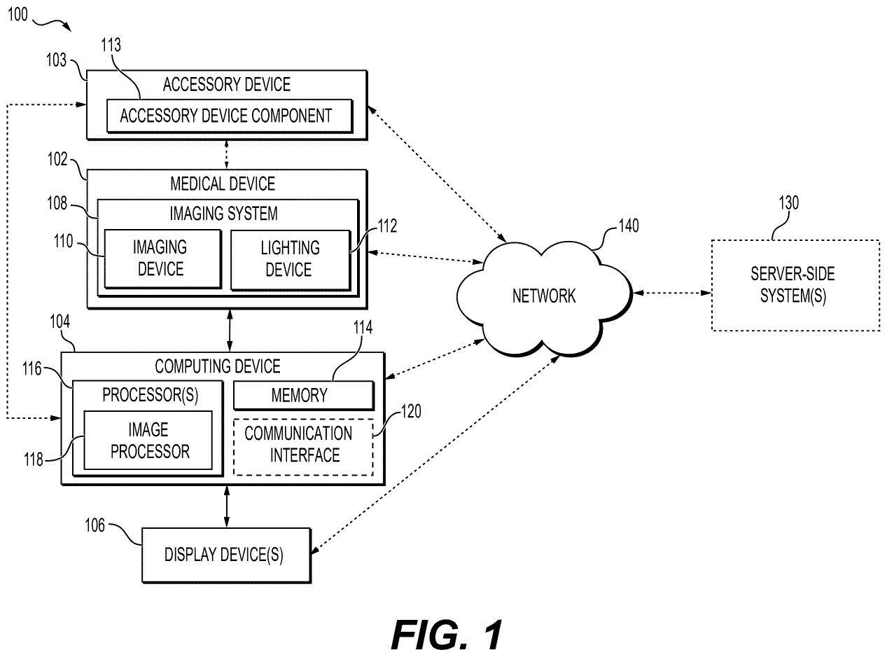

FIG. 1 depicts an example medical system 100 in which various processes disclosed herein may be implemented. Medical system 100 may include a medical device 102, an accessory device 103, a computing device 104, one or more display device(s) 106, one or more optional server side system(s) 130, and/or a network 140.

Medical device 102 may be used to perform a diagnostic and/or interventional medical procedure on a patient, hereinafter referred to as a medical procedure for brevity. Medical device 102 may be an endoscope or other type of scope, such as a bronchoscope, ureteroscope, duodenoscope, gastroscope, endoscopic ultrasonography (“EUS”) scope, colonoscope, laparoscope, arthroscope, cystoscope, aspiration scope, sheath, or catheter, among other examples.

Medical device 102 may include an imaging system 108. Imaging system 108 may include at least one imaging device 110 and at least one lighting device 112. Imaging device 110 may be located at a distal end of medical device 102 (e.g., at a distal tip of medical device 102). Imaging device 110 may be configured to continuously capture image signals as the distal end of medical device 102 is inserted into and navigated through a body lumen of the patient to a target site during the medical procedure. Imaging device 110 may include one or more cameras, one or more image sensors, one or more endoscopic viewing elements, or one or more camera assemblies including one or more image sensors and one or more lenses, among other similar devices.

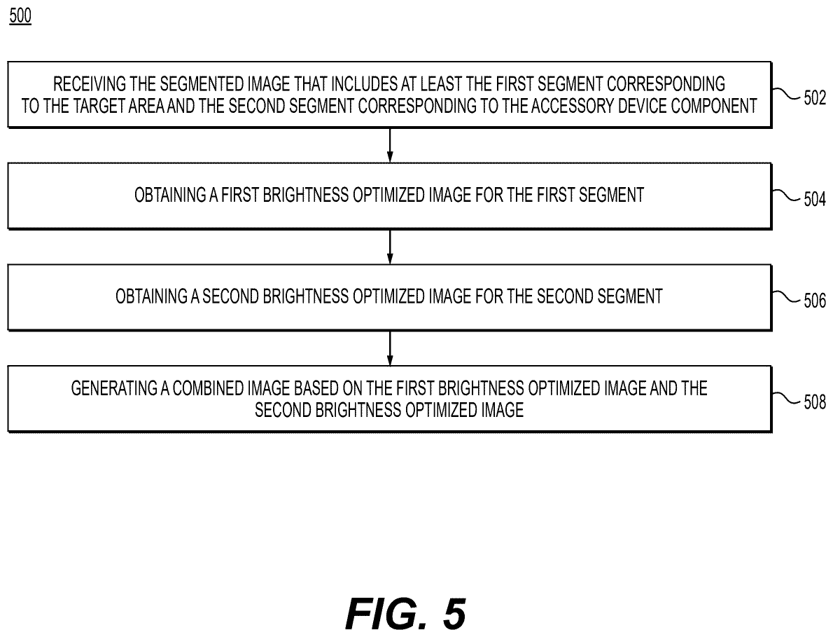

Within an example camera assembly, the image sensor(s) include a plurality of pixels (e.g., a grid of pixels) that convert detected photons to electrons. The signal charge generated from the electrons is converted into an electrical signal (e.g., a voltage), which may be further converted to a digital value using an Analog to Digital Converter (ADC), for example. The image signals are then provided to computing device 104 for processing into images. The lenses may be configured to focus the light onto and control an amount of the light that enters the image sensor(s). Each of the image sensor(s) may include a shutter that is configured to control a length of time that light is permitted to pass through the lenses to the image sensor(s) (e.g., control an exposure time). In some examples, the shutter is a global shutter. When shutter is a global shutter, all of the pixels of the image sensor(s) may be exposed simultaneously upon exposure to the light for a single image frame. In other examples, the shutter is a rolling shutter. When the shutter is a rolling shutter, the pixels of the image sensor(s) may be exposed row by row upon exposure to the light. This results in a delay. For example, as a first row of a current image frame is being exposed to light, a last row of a previous image frame is still being read out. Therefore, and as described in more detail below with reference to FIG. 5, computing device 104 may perform different image processing techniques dependent on a type of the shutter included in imaging device 110.

In some examples, lighting device 112 may be located at the distal end of medical device 102 (e.g., at the distal tip of medical device 102) along with imaging device 110. In other examples (not shown), lighting device 112 may be a separate device or may be integrated with computing device 104, with light from lighting device 112 being transmitted via fibers (e.g., optical fibers) extending a length of medical device 102 (e.g., from a proximal end of medical device 102 connected to computing device 104 to the distal tip of medical device 102). Lighting device 112 may be configured to illuminate areas of the patient's body (e.g., the target area) during the medical procedure to facilitate imaging of the target area by imaging device 110. Lighting device 112 may include one or more LEDs, incandescent light sources, optical fibers (e.g., optical fibers to transmit a light from a proximal light source), and/or other illuminators.

Accessory device 103 may be a separate device, tool, or instrument used in conjunction with medical device 102 to perform one or more operations during the medical procedure. In some aspects, accessory device 103 may have one or more accessory device components, including at least one accessory device component 113 that is mountable onto or otherwise attachable to the distal end of the medical device 102. Specifically, accessory device component 113 may extend distally from the distal tip of medical device 102. Such positioning may result in the distally-extending portion of accessory device component 113 partially blocking the field of view of imaging device 110 and/or altering the behavior of light emitted from lighting device 112.

To provide an illustrative example, accessory device component 113 may be an “over the scope” cap that mounts onto the distal tip of medical device 102 (e.g., an endoscope). This cap may be used in various endoscopic procedures such as Endoscopic Mucosal Resection (EMR), Endoscopic Submucosal Dissection (ESD), or endoscopic suturing. The cap may serve various functions depending on the specific procedure, such as providing a stable platform for tissue manipulation, improving visualization, and/or facilitating the deployment of other instruments, among other functions. While the specific examples disclosed herein describe accessory device component 113 as a cap, accessory device component 113 may be any type of structure or component of accessory device 103 having at least a portion thereof positioned distal relative to a distal face of medical device 102, such that the portion of accessory device component 113 partially obstructs a field of view of the imaging device 110 and/or affects a lighting behavior of the lighting device 112.

One or more components of medical device 102, including imaging system 108 and the components thereof, may be communicatively coupled to computing device 104 via wired connections and/or wireless connections (e.g., over network 140) to enable communication of various signals between medical device 102 and computing device 104. For example, image signals captured by imaging device 110 (e.g., raw image data) may be received by computing device 104. Additionally, computing device 104 may provide one or more signals to the imaging device 110 and/or lighting device 112 to cause one or more parameters of imaging device 110 and/or lighting device 112, respectively, to be adjusted, as described in detail below. Optionally, one or more components of accessory device 103 may be communicatively coupled to medical device 102 and/or computing device 104 via wired connections and/or wireless connections (e.g., over network 140) to enable communication.

In some examples, computing device 104 is a controller, a control unit, a computing device, or other similar standalone processing unit separate from medical device 102. In other examples, computing device 104 may be partially or fully integrated with medical device 102. For example, computing device 104 may be partially or fully positioned in a handle of medical device 102. As another example, computing device 104 may be partially or fully positioned at the distal end of medical device 102. Computing device 104 may be or at least include a field-programmable gate array (FPGA) comprising programmable logic blocks for performing various functions, including an automatic brightness control process, an image modification process, and/or an interleaved automatic brightness control process.

Computing device 104 may include a memory 114 and one or more processor(s) 116. Memory 114 may store instructions to be executed by processor(s) 116 to cause computing device 104 to perform corresponding operations. At least a portion of the instructions stored in memory 114 may include the automatic brightness control process, the image modification process, and/or the interleaved automatic brightness control process. Memory 114 may also include one or more data stores. Additionally or alternatively, computing device 104 may include one or more data stores separate from memory 114. Processor(s) 116 may include at least one image processor 118. Image processor 118 may be configured to process one or more image signals (e.g., raw image data) captured by imaging device 110 and received by computing device 104 to generate an image. In some examples, image processor 118 may be or include an FPGA, a digital signal processing (DSP) processor, a graphics processing unit (GPU), or the like.

Additionally, processor(s) 116 and/or image processor 118 may be configured to execute the automatic brightness control process, the image modification process, and/or the interleaved automatic brightness control process. In some examples, these processes may be features of the computing device 104 that can be manually enabled and disabled (e.g., turned on and off) by the operator. For example, graphical user interface control elements and/or buttons on medical device 102 may be actionable to turn one or more of the features on and off. As one illustrative example, the features may be presented as an “over the scope” cap mode to prompt the operator to enable the features when a cap is present. In other examples, the computing device 104, and particularly the image processor 118, may be configured to detect a presence of accessory device component 113 within an image captured by imaging device 110 (e.g., using one or more object detection techniques). In response to the detection, the computing device 104 may automatically enable (e.g., turn on) and execute one or more of the features.

Computing device 104 may further include an optional communication interface 120 for providing connectivity to network 140. Optional communication interface 120 may also provide connectivity to medical device 102 and/or display device(s) 106. In some examples, a communicative connection between computing device 104 and medical device 102 (or components thereof) and/or computing device 104 and display device(s) 106 may be at least partially supported via network 140.

Display device(s) 106 may be configured to display image data, including at least the image generated by computing device 104, as well as a brightness optimized image, a modified image, and/or a holistic brightness optimized image resulting from a performance of the automatic brightness control, image modification, and/or interleaved automatic brightness control processes. In some examples, the image data may also include the image with a visual indicator of a boundary (e.g., a boundary indicator) as part of the image segmentation process. Display device(s) 106 may include one or more a combination of monitors, computing device screens, touch screen display devices, etc. In some examples, one or more of the display device(s) 106 may be a separate device from computing device 104 that is communicatively coupleable to computing device 104 via wired and/or wireless connections. In other examples, at least one of display device(s) 106 may be a display of computing device 104 itself.

In some examples, computing device 104 may generate, or may cause to be generated, one or more graphical user interfaces based on instructions or information stored in memory 114, instructions or information received from one or more optional server side system(s) 130, and/or the like and may cause the graphical user interfaces to be displayed via display device(s) 106. The graphical user interfaces may be, e.g., application interfaces or browser user interfaces and may include text, selection controls, and/or the like, in addition to the displayed image data.

Display device(s) 106 may include a touch screen or a display with other input systems (e.g., a mouse, keyboard, voice, etc.) for an operator of computing device 104 to control functions of computing device 104, medical device 102 (or components thereof) via computing device 104, and/or display device(s) 106. As one example, the operator may select one or more of the control elements displayed on a graphical user interface of display device(s) 106 to enable (e.g., turn on) one or more features, such as the automatic brightness control, the image modification, and/or the interleaved automatic brightness control processes. As another example, the operator may select one or more of the control elements displayed on a graphical user interface of display device(s) 106 to resize and/or move the boundary indicator to indicate and/or adjust the boundary as part of the image segmentation process. As a further example, the operator may select one or more of the control elements displayed on a graphical user interface of display device(s) 106 to manually adjust one or more operating parameters of imaging system 108 (e.g., based on operator preferences). The selection may be received by computing device 104 and cause corresponding signals to be transmitted from computing device 104 to imaging system 108 and/or specific components thereof.

One or more components of medical system 100, such as medical device 102, accessory device 103, computing device 104, and/or display device(s) 106, may be capable of network connectivity, and may communicate with one another over a wired or wireless network, such as network 140. Network 140 may be an electronic network. Network 140 may include one or more wired and/or wireless networks, such as a wide area network (“WAN”), a local area network (“LAN”), personal area network (“PAN”), a cellular network (e.g., a 3G network, a 4G network, a 5G network, etc.), or the like. In other examples, the components of medical system 100 may communicate and/or connect to network 140 over universal serial bus (USB) or other similar local, low latency connections or direct wireless protocol. Components of medical system 100 may be connected via network 140, using one or more standard communication protocols, such that the component may transmit and receive communications from each other across network 140.

In some examples, when one or more of the components of medical system 100 are capable of connecting to network 140, medical system 100 may also include one or more optional server side system(s) 130. Optional server side system(s) 130 may include one or more of remote image processing systems configured to perform at least a portion of the image processing, including but not limited, more resource intensive processes, such as machine learning processes (e.g., to conserve local resources of computing device 104 when network connectivity is available). Additionally or alternatively, optional server side system(s) 130 may include data storage systems for storing the image generated by computing device 104 (e.g., in response to receiving an action input from the operator to record or otherwise save the image). In some examples, at least one of the data storage systems may include a picture archiving and communication system (PACS) that stores the image, along with other types of imaging data from various imaging modalities (e.g., ultrasound, magnetic resonance, nuclear medicine imaging, positron emission tomography, computed tomography, mammograms, digital radiography, histopathology, etc.) associated with the patient.

Although various components in medical system 100 are depicted as separate components in FIG. 1, it should be understood that a component or portion of a component in medical system 100 may, in some embodiments, be fully or partially integrated with or incorporated into one or more other components. For example, one of display device(s) 106 may be integrated with computing device 104 and/or computing device 104 may be integrated with medical device 102. In some embodiments, operations or aspects of one or more of the components discussed above may be distributed amongst one or more other components. Any suitable arrangement and/or integration of the various systems and devices of medical system 100 may be used.

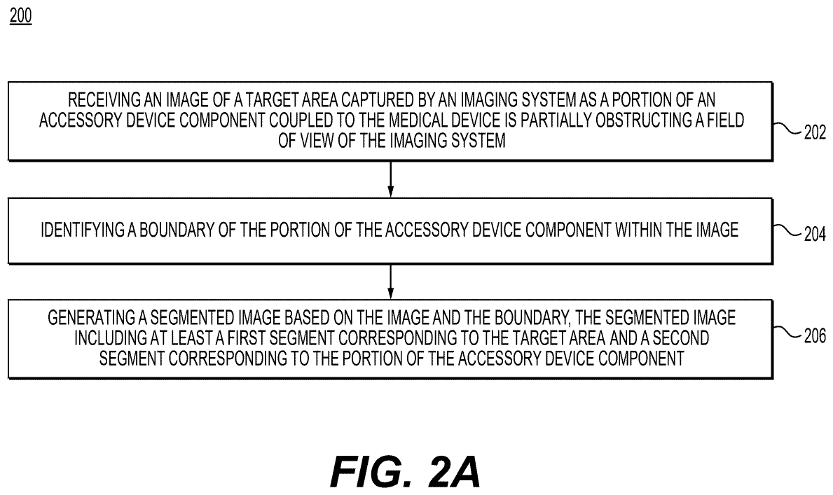

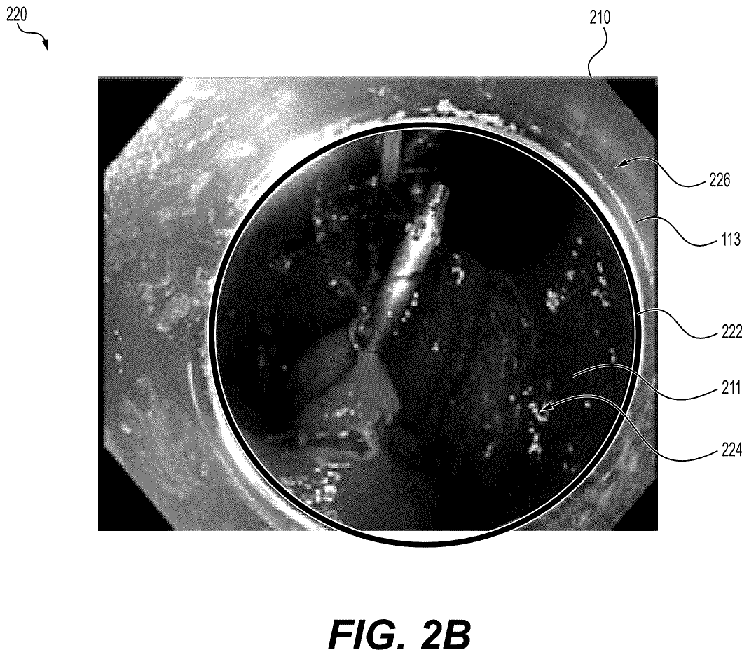

FIG. 2A depicts an example image segmentation method 200, hereinafter method 200. In some examples, one or more steps of method 200 may be performed by computing device 104. FIG. 2B depicts an example segmented image 220 generated using method 200.

Referring concurrently to FIGS. 2A and 2B, at step 202, method 200 may include receiving an image 210 of a target area 211. Image 210 may be captured by imaging system 108 of medical device 102 as the portion of accessory device component 113 coupled to and distally extending from medical device 102 is partially obstructing a field of view of imaging system 108. As a result, image 210 includes the portion of accessory device component 113, in addition to target area 211 comprising an anatomical site of interest. For example, as medical device 102 is positioned at, and lighting device 112 is emitting light to illuminate, target area 211, an image signal including raw image data of target area 211 captured by imaging device 110 may be received and processed by image processor 118 to generate image 210. In some examples, image 210 may be provided to one or more of display device(s) 106 for display. Image 210 may be a first image of target area 211 captured by and received from the imaging system 108.

At step 204, method 200 may include identifying a boundary of the portion of accessory device component 113 within image 210. The boundary identified may be a line, circle, curve, edge, or other similar distinguishing mark between (e.g., separating) the portion of accessory device component 113 and target area 211 within image 210. The boundary may be identified using one or a combination of the following techniques or approaches.

One example technique may include operator-based identification of the boundary. For example, and as shown in FIG. 2B, a boundary indicator 222 may be generated and displayed at a first location on image 210 as image 210 is displayed to an operator via a graphical user interface on one or more of display device(s) 106. Boundary indicator 222 may be indicative of the boundary. Boundary indicator 222 may be manipulatable or adjustable to enable operator-based identification of the boundary. For example, operator input, including a resizing of boundary indicator 222 and/or a movement of boundary indicator 222 to a second location, may be received via the graphical user interface to indicate the boundary. In some aspects, based on an expected shape associated with accessory device component 113, boundary indicator 222 may be generated to have a default size and form of the expected shape. For instance, when accessory device component 113 is a cap, the expected shape may be a circle, and boundary indicator 222 may be a circle having a default radius overlaid on a center of image 210. Boundary indicator 222 may be adjustable to allow the operator to then manipulate boundary indicator 222 to fit the boundary by resizing and/or moving the location. In some examples, the location of boundary indicator 222 may be moved when the portion of accessory device component 113 is offset from the center of image 210 (e.g., as boundary indicator 222 may be automatically overlaid on the center of image 210).

Another example technique may include automatic identification of the boundary. For example, one or more objects may be detected within image 210, and the boundary may be identified based on the one or more objects detected. Examples of the objects detected may include the portion of accessory device component 113 (e.g., an edge of the accessory device component 113) and/or one or more objects associated with target area 211, such as particular anatomy, foreign bodies, instruments, tools, etc. In some aspects, well-known object detection and/or pattern detection processes, including artificial intelligence-based processes, may be performed on image 210 to detect and distinguish the accessory device component 113 from target area 211 in order to automatically identify the boundary. In some examples, once the boundary is automatically identified, boundary indicator 222 corresponding to the automatically identified boundary may be overlaid on image 210 displayed via the graphical user interface on display device(s) 106. The operator may then manipulate boundary indicator 222, as described above, to adjust the boundary, as needed.

At step 206, method 200 may include generating a segmented image 220 based on image 210 and the boundary (e.g., represented by boundary indicator 222 in FIG. 2B). Segmented image 220 may be generated by segmenting image 210 into a plurality of segments, including at least a first segment 224 corresponding to target area 211 and a second segment 226 corresponding to the portion of accessory device component 113 (e.g., segments identifiable based on the boundary). In some examples, when the boundary is a circle (e.g., based on accessory device component 113 having a circular shape), first segment 224 may be an inner segment corresponding to an area interior to the boundary that includes target area 211. Second segment 226 may be an outer segment corresponding to an area exterior to the boundary that includes the portion of accessory device component 113 and other features, if any, of the image 210 that extend exteriorly from accessory device component 113. In other examples, second segment 226 may only include the portion of accessory device component 113, and any features of the image 210 that extend exteriorly from the cap may form an additional, outermost segment.

Image 210 may include a plurality of pixels. In some examples, once first segment 224 and second segment 226 have been identified via the generation of segmented image 220 from image 210, a first subset of the plurality of pixels within first segment 224 may be labeled as being associated with the first segment 224. Similarly, a second subset of the plurality of pixels within second segment 226 may be labeled as being associated with second segment 226. Each pixel within the first and second subsets may be respectively labeled. The labels may be stored in memory 114 of computing device 104 and/or other data stores communicatively coupled to computing device 104 (e.g., data storage systems of optional server side system(s) 130) to enable retrieval of the labels when further processing is performed on segmented image 220. Additionally or alternatively, a shape and location of first segment 224 and second segment 226 within segmented image 220 may be used to identify respective first and second subsets when further processing is performed. For example, segmented image 220 may be provided as an input for automatic brightness control processing, image modification processing, and/or interleaved automatic brightness control processing, each addressed in turn below.

Accordingly, certain aspects may include performing image segmentation processes. Method 200 described above is provided merely as an example, and may include additional, fewer, different, or differently arranged steps than depicted in FIG. 2A.

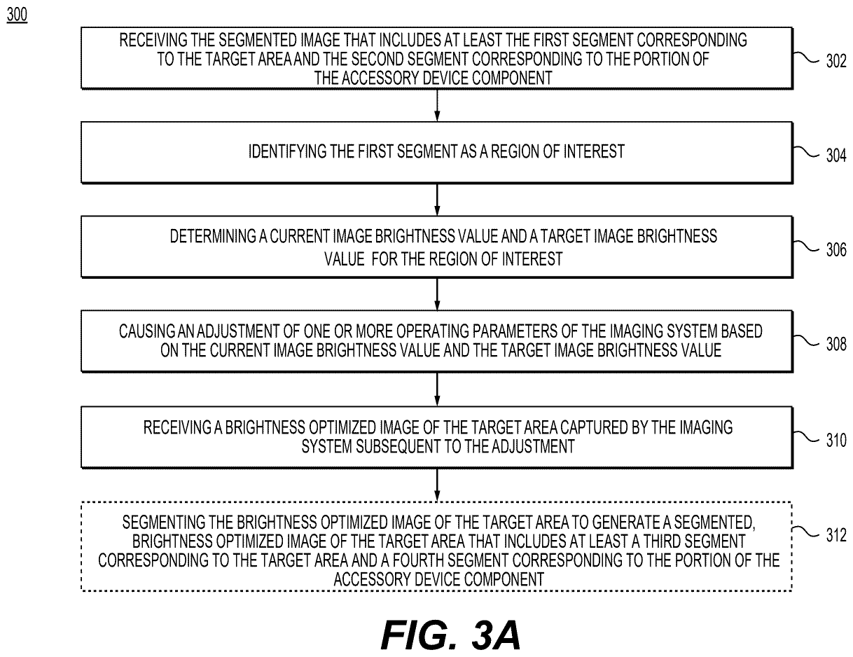

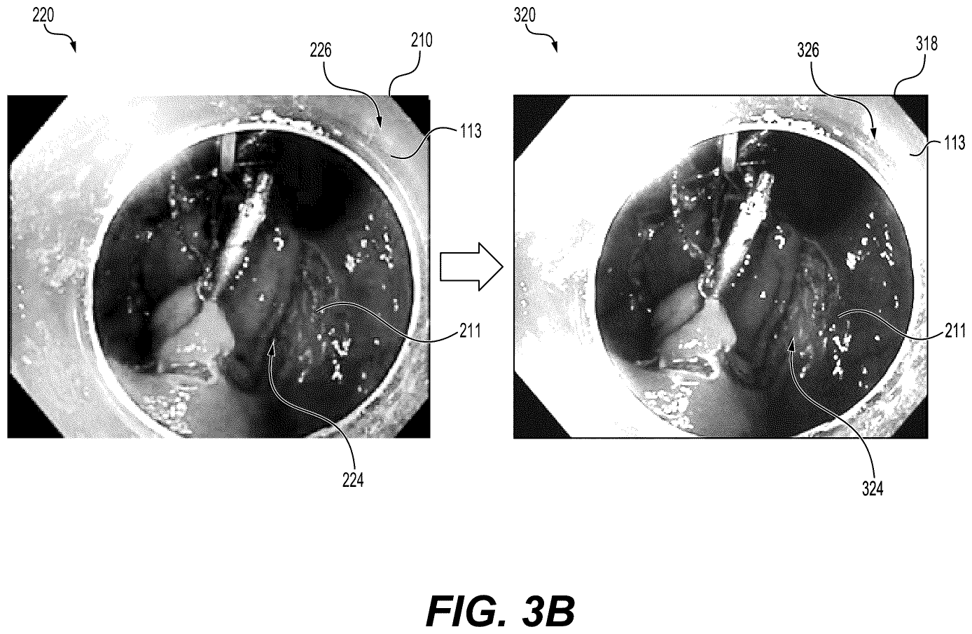

FIG. 3A depicts an example method 300 for performing automatic brightness control, hereinafter method 300. In some examples, one or more steps of method 300 may be performed by computing device 104. The automatic brightness control described by method 300 may leverage segmentation to identify a region of interest for brightness optimization. Therefore, method 300 may be performed in conjunction with, and specifically subsequent to, method 200 to leverage segmented image 220 to perform automatic brightness control to obtain a brightness optimized image 318. FIG. 3B shows a comparison of image 210 and brightness optimized image 318.

Referring concurrently to FIGS. 3A and 3B, at step 302, method 300 may include receiving segmented image 220 that includes at least first segment 224 corresponding to target area 211 and second segment 226 corresponding to the portion of accessory device component 113. Segmented image 220 may be generated from image 210 using method 200 described above with reference to FIG. 2A.

Image quality of target area 211 within first segment 224 may be critical for operator visibility during the medical procedure, whereas second segment 226 may provide limited data to the operator. Therefore, in some embodiments, the automatic brightness control adjustment performed using method 300 may be based only on feedback from first segment 224 to increase image brightness that improves visibility to a desired level within first segment 224. In such embodiments, at step 304, method 300 may include identifying first segment 224 as a region of interest.

At step 306, method 300 may include determining a current image brightness value and a target image brightness value for the region of interest. For example, pixel values that represent an intensity or brightness of the first subset of pixels included in first segment 224 (e.g., pixel intensity values of the first subset of pixels) may be averaged to determine the current image brightness value for first segment 224 (e.g., the actual image brightness value for first segment 224 of segmented image 220). For example, an average pixel intensity value for the first subset of pixels may be the current image brightness value. In some examples, the first subset of pixels included in first segment 224 may be identified based on labeling performed as part of the image segmentation process. In other examples, the first subset of pixels included in first segment 224 may be identified based on a shape and location of first segment 224 within segmented image 220.

The target brightness value may be a predefined value for optimal (or otherwise improved) visualization. Specifically, the target brightness value may be a predefined percentage value of brightness on a scale of 0% (e.g., a fully black image) to 100% (e.g., a fully white image). As one non-limiting example, the target brightness value may be 40%+/−5% brightness. The target brightness value may be stored in memory 114 of computing device 104 and/or other data stores communicatively coupled to computing device 104 (e.g., data storage systems of optional server side system(s) 130) to enable retrieval of the target brightness value for use in method 300. In some examples, the target brightness value may be adjusted from the predefined value based on operator preferences. For example, the operator may interact with computing device 104 and/or display device(s) 106 (e.g., by providing input via one or more associated input systems or devices) to adjust the brightness value. In some examples, the adjusted brightness value may be saved and stored in association with the operator in memory 114 and/or other data sources for subsequent retrieval and use.

At step 308, method 300 may include causing an adjustment of one or more operating parameters of imaging system 108 based on the determined current brightness value and target image brightness value. For example, a difference between the current image brightness value and the target brightness value may be determined. The difference may be utilized to adjust the one or more operating parameters such that the target brightness value is achieved for the identified region of interest (e.g., for first segment 224).

In some examples, one operating parameter adjusted may be an intensity of light emitted by lighting device 112. To adjust the intensity, based on the current image brightness value, computing device 104 may control (e.g., may increase or decrease) an amount of current supplied to lighting device 112 to cause the intensity of light emitted by lighting device 112 to meet the target image brightness value. For example, a correlation between a value of current supplied to and light intensity emitted from lighting device 112 may be known based on information provided by a manufacturer of lighting device 112 and/or based on calibrations performed prior to distribution and/or use of medical device 102. Using the known correlation, computing device 104 may adjust the value of current supplied to lighting device 112 resulting in the current image brightness value to the value of current corresponding to a value of light intensity that meets the target image brightness value. The adjustment may be further dependent on a type of the anatomy at the target area. In some examples, computing device 104 may implement a Proportional Integral Derivative (PID) loop to control the intensity adjustment. Additionally or alternatively, dependent on a type of lighting device 112, computing device 104 may adjust one or more filters located between lighting device 112 and one or more fibers to adjust the intensity of light emitted, or reduce brightness of lighting device 112.

Another example operating parameter adjusted may be a gain of imaging device 110. Based on the current image brightness value, computing device 104 may send signals to imaging device 110 to control (e.g., to increase or decrease) gain to achieve an apparent image brightness that meets the target image brightness value. Gain adjustment is one example means of adjusting an apparent sensitivity of imaging device 110 to light. For example, the gain may represent a relationship between a number of electrons acquired on an image sensor of imaging device 110 and analog-to-digital units (ADUs) that are generated, representing the image signal. Increasing the gain amplifies the signal by increasing the ratio of ADUs to electrons acquired on the image sensor. Therefore, increasing gain may increase the apparent brightness of an image at a given exposure. Conversely, decreasing gain may decrease the apparent brightness.

A further example operating parameter adjusted may be an exposure time of imaging device 110. Based on the current image brightness value, computing device 104 may send signals to imaging device 110 to control (e.g., to increase or decrease) exposure time to achieve an image brightness that meets the target image brightness value. The exposure time of imaging device 110, also referred to as shutter speed, may be a duration that the image sensor is exposed to the light. Increasing the duration may cause more light to be received by the sensor, resulting in increased pixel intensity and brightness of an image. Conversely, decreasing the duration may cause less light to be received by the sensor, resulting in decreased pixel intensity and brightness of the image.

At step 310, method 300 may include receiving a brightness optimized image 318 of target area 211 captured by imaging system 108 subsequent to the adjustment. For example, after the operating parameter(s) of imaging device 110 and/or lighting device 112 have been adjusted, an image signal including raw image data of target area 211 captured by imaging device 11, as lighting device 112 is illuminating target area 211, may be received and processed by image processor 118 to generate brightness optimized image 318. Brightness optimized image 318 may be a second image of target area 211 captured by and received from the imaging system 108. In some examples, brightness optimized image 318 may be provided to one or more of display device(s) 106 for display.

In some aspects, brightness optimized image 318 may be further processed. For example, at optional step 312, method 300 may include segmenting brightness optimized image 318 to generate a segmented, brightness optimized image 320. The image segmentation process described above with reference to method 200 of FIG. 2A may be used to generate segmented, brightness optimized image 320. As shown in FIG. 3B, segmented, brightness optimized image 320 may be generated by segmenting image 210 into a plurality of segments, including at least a third segment 324 and a fourth segment 326 (e.g., two segments identifiable based on a boundary determined therebetween). Third segment 324 may correspond to target area 211, similar to first segment 224 in segmented image 220. Fourth segment 326 may correspond to the portion of accessory device component 113, similar to second segment 226 in segmented image 220.

In some examples, the automatic brightness control performed by method 300 may be a continuous or iterative process. For example, steps 304-308 may be repeated for one or more brightness optimized images that are received following an adjustment and segmented (e.g., at step 310 and optional step 312), including segmented, brightness optimized image 320. In such examples, a respective segment corresponding to target area 211 is identified as the region of interest at step 304, such as third segment 324 of segmented, brightness optimized image 320. The process may be repeated until target area 211 is of an optimal or desirable brightness, for example.

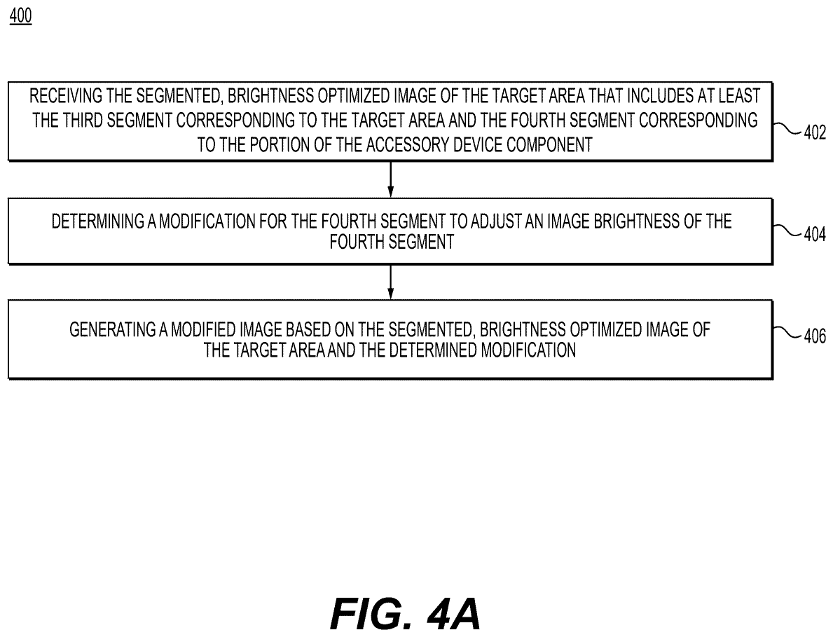

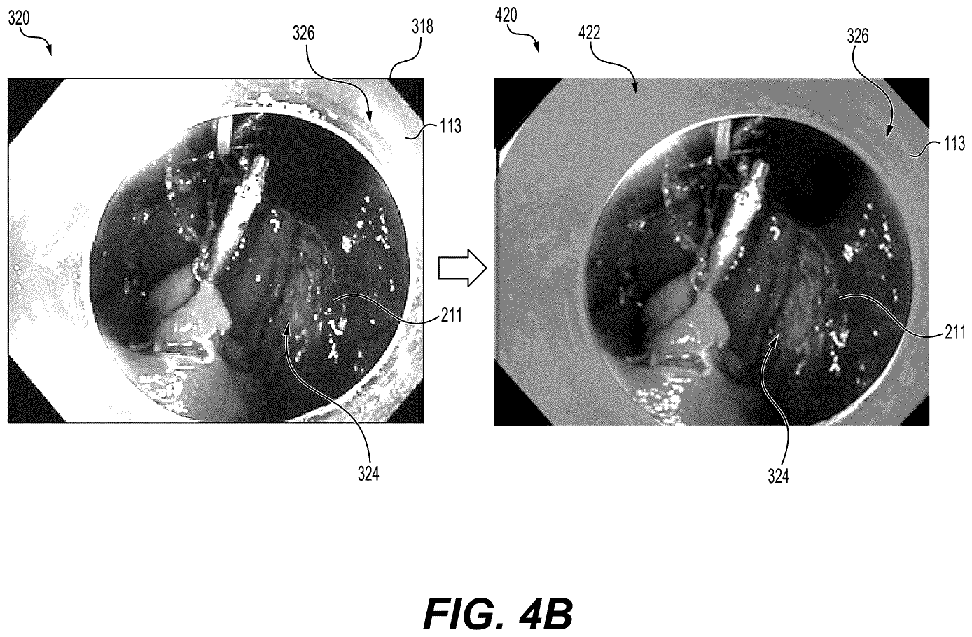

Additionally or alternatively, segmented, brightness optimized image 320 (or another segmented, brightness optimized image received subsequent thereto following one or more iterations of the automatic brightness control process) may be generated to provide as input to another process, such as an image modification process performed in conjunction with the automatic brightness control process, as described with reference to FIG. 4A. While optimizing brightness for a segment, such as first segment 224, corresponding to target area 211, may help to improve (e.g., optimize) operator visibility of target area 211 during the procedure, such optimization/improvement also impacts (e.g., increases the brightness of) other image portions or segments. For example, and as shown in brightness optimized image 318 of FIG. 3B, the optimization/improvement may result in additional or enhanced hotspots and/or oversaturated images within other image portions (e.g., the image portion including the accessory device component 113), which may potentially distract the operator from target area 211. Therefore, in such examples, brightness optimized image 318 may be further processed and modified to mitigate this impact.

Method 300, as described above, identifies first segment 224 as the region of interest. In some embodiments, first segment 224 may be identified as a first region of interest at step 304, which results in the receiving of brightness optimized image 318 as a first brightness optimized image for first segment 224 utilizing steps 306-310. Another iteration of method 300 may then be performed based upon identifying second segment 226 as a second region of interest at step 304, which results in the receiving of a second brightness optimized image for second segment 226 utilizing steps 306-310. For example, a target image brightness value may be determined for second segment 226 to cause an adjustment of the one or more operating parameters of imaging system 108 based on the determined target image brightness value for second segment 226, and a second brightness optimized image for second segment 226 captured by imaging system 108 subsequent to the adjustment may be received. In some examples, the first brightness optimized image and the second brightness optimized image may be further processed, as described with reference to FIG. 5.

Accordingly, certain aspects may include performing segmentation-based automatic brightness control processes. Method 300 described above is provided merely as an example, and may include additional, fewer, different, or differently arranged steps than depicted in FIG. 3A.

FIG. 4A depicts an example image modification method 400, hereinafter method 400. In some examples, one or more steps of method 400 may be performed by computing device 104. In some aspects, method 400 may be performed in conjunction with, and specifically subsequent to, method 300. For example, while the brightness optimization achieved for target area 211 within brightness optimized image 318 may help to improve operator visibility of target area 211 during the procedure, the optimization may also impact (e.g., result in additional or enhanced hotspots and/or oversaturation of) other portions of brightness optimized image 318, such as the portion including accessory device component 113. Therefore, to mitigate this impact, the brightness optimized image 318 may be segmented to generate segmented, brightness optimized image 320, as described with reference to optional step 312 of method 300, and further processed using method 400 to generate a modified image 420. FIG. 4B shows an example comparison of segmented, brightness optimized image 320 and modified image 420.

Referring concurrently to FIGS. 4A and 4B, at step 402, method 400 may include receiving segmented, brightness optimized image 320 of target area 211. Segmented, brightness optimized image 320 may include third segment 324 corresponding to target area 211 and fourth segment 326 corresponding to the portion of accessory device component 113.

At step 404, method 400 may include determining a modification for fourth segment 326 to adjust an image brightness of fourth segment 326. Specifically, the modification determined may be to reduce or decrease the image brightness of fourth segment 326.

In some examples, the determined modification may include an overlay corresponding to fourth segment 326. In some aspects, the overlay may be a fixed overlay. The fixed overlay may have varying transmissive properties. For example, the overlay may be a semi-transmissive overlay applied to each pixel of fourth segment 326 within segmented, brightness optimized image 320 to generate an overlay image that reduces or decreases the image brightness of fourth segment 326. No modifications may be made to third segment 324 when generating the overlay image.

In other aspects, the overlay may be an adjustable overlay. For example, to generate an overlay image, an intensity value of each pixel of the fourth segment 326 may be adjusted by a predetermined percentage value. Again, no modifications may be made to third segment 324 when generating the overlay image.

In other examples, the determined modification may include applying a digital gain to fourth segment 326 to meet a desired target brightness value within the fourth segment 326.

For the above-described overlay or gain applications and/or adjustments, each pixel of fourth segment 326 may be identified based on labeling performed as part of the image segmentation process and/or based on a shape and location of fourth segment 326 within segmented, brightness optimized image 320.

At step 406, method 400 may include generating modified image 420 based on segmented, brightness optimized image 320 of target area 211 and the modification. When the modification includes an overlay, the generated overlay image may be combined with (e.g., blended with) segmented, brightness optimized image 320 to generate modified image 420. Resultantly, and as shown in FIG. 4B, modified image 420 may include an overlay 422 corresponding to (e.g., overlaid on) fourth segment 326. For example, overlay 422 may essentially mask the portion of accessory device component 113. When the modification includes a digital gain application, modified image 420 may be generated by adjusting, and specifically decreasing, pixel values that represent an intensity or brightness of a subset of pixels included in fourth segment 326 of segmented, brightness optimized image 320 to a desired image brightness value.

In some examples, control elements may be provided via a graphical user interface displayed on the display device(s) 106 that allow the operator to further adjust the image brightness of fourth segment 326 displayed in modified image 420. For example, the operator may adjust the image brightness of the overlay image or adjust a digital gain factor, dependent on the modification determined and modified image 420 generated based thereon.

As described with reference to FIGS. 4A and 4B, method 400 may be applied to segmented, brightness optimized image 320 when method 400 is performed in conjunction with method 300. In other aspects, method 400 may be applied independently from method 300 to a segmented image, such as segmented image 220 generated using the segmentation process described with reference to method 200 of FIG. 2A. In such aspects, a modification for second segment 226 of segmented image 220 may be determined at step 406 for use in generating a modified image at step 406 using segmented image 220 and the modification.

Accordingly, certain aspects may include performing segmentation-based image modification processes independently or in conjunction with automatic brightness control processes. Method 400 described above is provided merely as an example, and may include additional, fewer, different, or differently arranged steps than depicted in FIG. 4A.

FIG. 5 depicts an example method 500 for performing interleaved automatic brightness control, hereinafter method 500. In some examples, one or more steps of method 500 may be performed by computing device 104. At step 502, method 500 may include receiving segmented image 220 that includes at least first segment 224 corresponding to target area 211 and second segment 226 corresponding to the portion of accessory device component 113. Segmented image 220 may be generated using the image segmentation process of method 200 described above with reference to FIG. 2A.

At step 504, method 500 may include obtaining a first brightness optimized image for first segment 224. For example, the first brightness optimized image may be brightness optimized image 318 obtained using the automatic brightness control process described with reference to method 300 of FIG. 3A. Specifically, first segment 224 may be identified as the region of interest, a target image brightness value may be determined based on first segment 224, and one or more operating parameters of imaging system 108 may be adjusted based on the determined target image brightness value. For example, the operating parameters may be adjusted from a default set of parameters to a first set of operating parameters to optimize brightness for first segment 224. The first brightness optimized image may be received subsequent to the adjustment (e.g., as imaging system 108 is operating using the first set of operating parameters). For example, after the operating parameters of imaging device 110 and/or lighting device 112 have been adjusted to the first set of operating parameters, an image signal including raw image data of target area 211 captured by imaging device 110 as lighting device 112 is illuminating target area 211 may be received and processed by image processor 118 to generate the first brightness optimized image.

At step 506, method 500 may include obtaining a second brightness optimized image for second segment 226. For example, the second brightness optimized image may be obtained by performing another iteration of the automatic brightness control process described with reference to method 300 of FIG. 3A, but where second segment 226 is identified as the region of interest. Specifically, following identification of second segment 226 as the region of interest, a target image brightness value may be determined based on second segment 226 to cause another adjustment of the one or more parameters of imaging system 108 based on the determined target image brightness value. For example, the operating parameters may be adjusted from the first set to a second set of operating parameters to optimize brightness for second segment 226. The second brightness optimized image may be received subsequent to the adjustment (e.g., as imaging system 108 is operating using the second set of operating parameters). For example, after the operating parameters of imaging device 110 and/or lighting device 112 have been adjusted to the second set of operating parameters, an image signal including raw image data of target area 211 captured by imaging device 110 as lighting device 112 is illuminating target area 211 may be received and processed by image processor 118 to generate the second brightness optimized image.

Computing device 104 may control imaging system 108 to switch from operating in accordance with the first set of operating parameters to the second set of operating parameters. In some examples, imaging device 110 may include a global shutter configured to control a period of image frame exposure. In such examples, computing device 104 may cause imaging system 108 to switch from operating in accordance with the first set to the second set of operating parameters at an end of the period of image frame exposure.

In other examples, the imaging device 110 may include a rolling shutter configured to control a period of image frame exposure. In such examples, receiving the second brightness optimized image may include receiving a plurality of image frames, where, based on the rolling shutter, a portion of the image frames may include mixed image frames that are exposed to a mix of the first and second set of operating parameters as the computing device 104 controls imaging system 108 to switch from operating in accordance with the first set to the second set of operating parameters. Additional image processing may be performed to identify and discard the mixed image frames.

At step 508, method 500 may include generating a combined image based on the first brightness optimized image and the second brightness optimized image. The combined image may be a holistic, brightness optimized image for each of first segment 224 and second segment 226. In some examples, the combined image may be provided to one or more of display device(s) 106 for display.

In some aspects, the interleaved automatic brightness control process described by method 500 may be continuously repeated in conjunction with the image segmentation process (e.g., as described by method 200), and alternate between obtaining brightness optimized images for first segment 224 and second segment 226 to generate combined images for display.

Accordingly, certain aspects may include performing interleaved automatic brightness control. Method 500 described above is provided merely as an example, and may include additional, fewer, different, or differently arranged steps than depicted in FIG. 5.

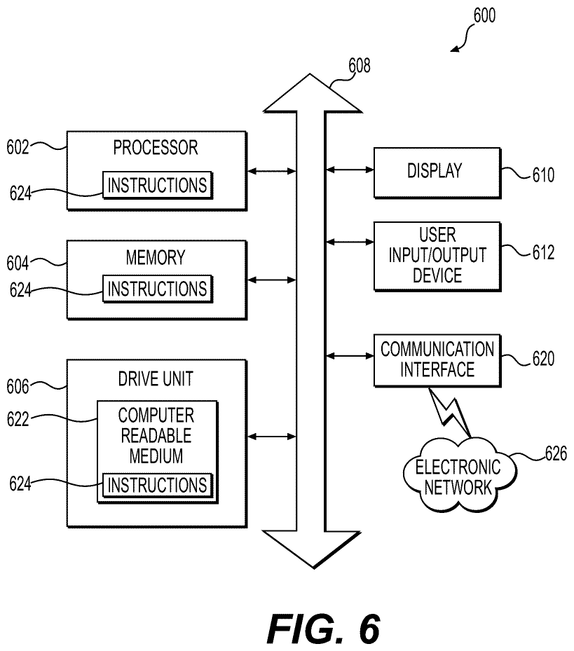

FIG. 6 depicts an example of a computer 600. FIG. 6 is a simplified functional block diagram of computer 600 that may be configured as a device for executing processes, steps, or operations depicted in, or described with respect to, FIGS. 2A-5 and, according to exemplary embodiments of the disclosure. For example, computer 600 may be configured as one or more of medical device 102, accessory device 103, computing device 104, display device(s) 106, optional server side system(s) 130, and/or another device or component according to exemplary embodiments of this disclosure. In various embodiments, any of the systems herein may be or include computer 600 including, e.g., a data communication interface 620 for packet data communication. Computer 600 may communicate with one or more other computers, for example, using an electronic network 626 (e.g., via data communication interface 620). Electronic network 626 may include a wired or wireless network, for example, similar to network 140 depicted in FIG. 1.

Computer 600 also may include a central processing unit (“CPU”), in the form of one or more processors 602, for executing program instructions 624. Program instructions 624 may include at least instructions for performing one or more of processes, including image segmentation, automatic brightness control, image modification, and/or interleaved automatic brightness control (e.g., if computer 600 is computing device 104).

Computer 600 may include an internal communication bus 608. Computer 600 may also include a drive unit 606 (such as read-only memory (ROM), hard disk drive (HDD), solid-state disk drive (SDD), etc.) that may store data on a computer readable medium 622 (e.g., a non-transitory computer readable medium), although computer 600 may receive programming and data via network communications. Computer 600 may also have a memory 604 (such as random-access memory (RAM)) storing instructions 624 for executing techniques presented herein. It is noted, however, that in some aspects, instructions 624 may be stored temporarily or permanently within other modules of computer 600 (e.g., processor 602 and/or computer readable medium 622). Computer 600 also may include user input and output devices 612 and/or a display 610 to connect with input and/or output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may, at times, be communicated through the Internet or various other telecommunication networks. Such communications, e.g., may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

We claim:

1. A computing device-implemented method for performing automatic brightness control, the method comprising:
receiving a first image of a target area captured by an imaging system of a medical device, wherein the first image is captured as a portion of an accessory device component coupled to and distally extending from the medical device is partially obstructing a field of view of the imaging system, causing the first image to include the portion of the accessory device component;
segmenting the first image into a first plurality of segments, including a first segment corresponding to the target area and a second segment corresponding to the portion of the accessory device component;
determining a current image brightness value for the first segment;
causing an adjustment to one or more operating parameters of the imaging system based on the current image brightness value and a target image brightness value for the first segment; and
receiving, as a second image of the target area captured by the imaging system subsequent to the adjustment, a brightness optimized image for the first segment.

2. The computing device-implemented method of claim 1, wherein segmenting the first image into the first plurality of segments comprises:
identifying a boundary between the portion of the accessory device component and the target area within the first image; and
identifying the first plurality of segments based on the boundary.

3. The computing device-implemented method of claim 2, wherein identifying the boundary comprises:
detecting one or more objects within the first image, the one or more objects including one or more of the portion of the accessory device component or one or more objects associated with the target area; and
identifying the boundary based on the one or more objects detected.

4. The computing device-implemented method of claim 2, wherein identifying the boundary comprises:
generating and causing display of a boundary indicator at a first location on the first image as the first image is displayed to an operator via a graphical user interface displayed on a display device; and
receiving an input from an operator via the graphical user interface, the input including one or more of a resizing of the boundary indicator or a movement of the boundary indicator to a second location to indicate the boundary.

5. The computing device-implemented method of claim 1, wherein determining the current image brightness value for the first segment comprises:
determining an average pixel intensity value for a first subset of pixels of the first image comprising the first segment, wherein the average pixel intensity value is the current image brightness value.

6. The computing device-implemented method of claim 1, wherein the imaging system includes a lighting device configured to illuminate the target area, and wherein causing the adjustment of the one or more operating parameters of the imaging system comprises:
causing an adjustment of an intensity of light emitted by the lighting device to illuminate the target area, wherein the intensity of light is adjusted by controlling an amount of current supplied to the lighting device.

7. The computing device-implemented method of claim 1, wherein the imaging system includes an imaging device configured to capture the first image, and wherein causing the adjustment of the one or more operating parameters of the imaging system comprises:
causing an adjustment of one or more of a gain or an exposure time of the imaging device.

8. The computing device-implemented method of claim 1, wherein the brightness optimized image also includes the portion of the accessory device component, and wherein the method further comprises:
segmenting the brightness optimized image into a second plurality of segments, including a third segment corresponding to the target area and a fourth segment corresponding to the portion of the accessory device component, to generate a segmented, brightness optimized image.

9. The computing device-implemented method of claim 8, further comprising:
determining a modification for the fourth segment to adjust an image brightness of the fourth segment; and
generating a modified image based on the segmented, brightness optimized image and the modification.

10. The computing device-implemented method of claim 9, wherein the modification is an overlay, and generating the modified image comprises:
applying the overlay to the fourth segment of the segmented, brightness optimized image to generate an overlay image; and
combining the overlay image with the segmented, brightness optimized image to generate the modified image.

11. The computing device-implemented method of claim 9, wherein the modification is a digital gain application, and generating the modified image comprises:
applying a digital gain factor to pixel values of the fourth segment of the segmented, brightness optimized image to generate the modified image.

12. The computing device-implemented method of claim 1, wherein the brightness optimized image for the first segment is a first brightness optimized image, and the method further comprises:
obtaining a second brightness optimized image for the second segment; and
generating a combined image based on the first brightness optimized image and the second brightness optimized image.

13. The computing device-implemented method of claim 12, wherein obtaining the second brightness optimized image for the second segment comprises:
determining a current image brightness value for the second segment;
after the second image of the target area is captured by the imaging system, causing an other adjustment of the one or more operating parameters of the imaging system based on the current image brightness value for the second segment and a target image brightness value for the second segment; and
receiving, as a third image of the target area captured by the imaging system, the second brightness optimized image for the second segment.

14. The computing device-implemented method of claim 13, wherein causing the other adjustment of the one or more operating parameters of the imaging system based on the current image brightness value for the second segment includes controlling the imaging system to switch from operating in accordance with a first set of operating parameters to a second set of operating parameters.

15. The computing device-implemented method of claim 1, further comprising:
detecting the portion of the accessory device component in the first image; and
performing the automatic brightness control based on the detection.

16. A computing device communicatively coupled to a medical device for performing automatic brightness control, comprising:
at least one memory storing instructions; and
at least one processor coupled to the at least one memory and configured to execute the instructions to perform operations including:
receiving, from an imaging system of the medical device, an image of a target area captured by an imaging device of the imaging system as the target area is illuminated by a lighting device of the imaging system, wherein the image includes a portion of an accessory device component that is coupled to and distally extends from the medical device;
identifying a boundary between the portion of the accessory device component and the target area in the image;
generating a segmented image based on the image and the boundary, the segmented image including a first segment corresponding to the target area and a second segment corresponding to the portion of the accessory device component;
determining a current image brightness value for the first segment;
causing an adjustment of one or more operating parameters of one or more of the lighting device or the imaging device based on the current image brightness value and a target image brightness value for the first segment; and
receiving, as a subsequent image of the target area from the imaging system, a brightness optimized image for the first segment based on the adjustment.

17. The computing device of claim 16, wherein the brightness optimized image also includes the portion of the accessory device component, and the operations further include:
identifying a second boundary between the portion of the accessory device component and the target area in the brightness optimized image;
generating a segmented, brightness optimized image based on the boundary and the brightness optimized image, the segmented, brightness optimized image including a third segment corresponding to the target area and a fourth segment corresponding to the portion of the accessory device component;
determining a modification for the fourth segment to adjust an image brightness of the fourth segment; and
generating a modified image based on the segmented, brightness optimized image and the modification.

18. The computing device of claim 16, wherein the brightness optimized image for the first segment is a first brightness optimized image, and the operations further include:
obtaining a second brightness optimized image for the second segment; and
generating a combined image based on the first brightness optimized image and the second brightness optimized image.

19. A medical system comprising:
a medical device;
an imaging system located at a distal tip of the medical device;
an accessory device including an accessory device component, wherein a portion of the accessory device component is positioned distal of the distal tip; and
a computing device communicatively coupled to at least the medical device, the computing device comprising:
at least one memory storing instructions; and
at least one processor coupled to the at least one memory and configured to execute the instructions to perform operations including:
receiving an image of a target area captured by the imaging system, the image including the portion of the accessory device component based on the positioning of the portion of the accessory device component relative to the imaging system;
segmenting the image into a first segment corresponding to the target area and a second segment corresponding to the portion of the accessory device component;
determining a current image brightness value for the first segment;
causing an adjustment of one or more operating parameters of the imaging system based on the current image brightness value and a target image brightness value; and
receiving a brightness optimized image of the target area captured by the imaging system based on the adjustment.

20. The medical system of claim 19, wherein the medical device is an endoscope and the accessory device component is a cap.
